(19) United States
(12) Patent Application Publication
(10) Pub. No.: US 2026/0197595 A1
(43) Pub. Date: Jul. 9, 2026

(54) METHOD AND DEVICE FOR CALIBRATING MICROPHONE ARRAY OF HEADSET AND HEADSET

(71) Applicant: MERRY ELECTRONICS (SHENZHEN) CO., LTD., ShenZhen (CN)

(72) Inventors: Tianliang ZHANG, Shenzhen (CN); Hao ZHANG, Shenzhen (CN); Hang GUAN, Shenzhen (CN)

(21) Appl. No.: 19/089,875

(22) Filed: Mar. 25, 2025

(30) Foreign Application Priority Data
Jan. 6, 2025 (CN) 202510017809.3

(51) Int. Cl. H04R 29/00; H04R 1/10; H04R 1/40; H04R 3/00

(52) U.S. Cl. CPC H04R 29/005; H04R 1/1008; H04R 1/1075; H04R 1/406; H04R 3/005

(57) ABSTRACT

Disclosed are a method and a device for calibrating a microphone array of a headset, and a headset. The headset includes a headset body and a microphone array arranged on the headset body. The microphone array includes a plurality of microphones. The method includes: obtaining a preset reference distance of each microphone; detecting a current body direction of the headset body, and determining a distance between each microphone and the sound source to obtain a target distance of each microphone corresponding to a determination that a detected current body direction of the headset body is deflected relative to the preset body direction; obtaining a preset acoustic parameter reference value of each microphone; comparing the target distance of each microphone with the preset reference distance of a corresponding microphone, and updating the preset acoustic parameter reference value of each microphone; and calibrating the microphone array.

### CROSS-REFERENCE TO RELATED APPLICATION

The present application claims the priority of Chinese patent application No. 202510017809.3, filed on Jan. 6, 2025, and entitled “METHOD AND DEVICE FOR CALIBRATING MICROPHONE ARRAY OF HEADSET AND HEADSET”, which is incorporated herein by reference in its entirety.

### TECHNICAL FIELD

The present application relates to the technical field of microphone array calibration, and in particular to a method and a device for calibrating a microphone array of a headset and a headset.

### BACKGROUND

With the development of computer technology, headsets emerged. A headset may include a headset body, in which a microphone array may be arranged, and sound in the environment where the headset is located is collected by the microphone array. Usually, when the headset leaves the factory, it is preset that the headset body will be in a preset body direction when the user wears the headset. Based on this, the acoustic parameter reference values of each microphone of the microphone array are preset, and in an actual use, the microphone array is calibrated based on the acoustic parameter reference values of each microphone.

### SUMMARY

The present provide a method and a device for calibrating a microphone array of a headset and a headset.

In a first aspect, the present application provides a method for calibrating a microphone array of a headset. The headset includes a headset body and a microphone array arranged on the headset body for collecting sounds generated by a sound source; the microphone array includes a plurality of microphones; and the method includes: obtaining a preset reference distance of each microphone, the preset reference distance being a distance between each microphone and the sound source when the headset body is in a preset body direction; detecting a current body direction of the headset body, and determining a distance between each microphone and the sound source to obtain a target distance of each microphone corresponding to a determination that a detected current body direction of the headset body is deflected relative to the preset body direction; obtaining a preset acoustic parameter reference value of each microphone, the preset acoustic parameter reference value being an acoustic parameter reference of each microphone corresponding to the headset body in the preset body direction and used for calibrating the microphone array; comparing the target distance of each microphone with the preset reference distance of a corresponding microphone, and updating the preset acoustic parameter reference value of each microphone according to a comparison result, to obtain a target acoustic parameter value of each microphone; and calibrating the microphone array according to the target acoustic parameter value of each microphone of the microphone array.

In a second aspect, the present application also provides a device for calibrating a microphone array of a headset. The headset includes a headset body and a microphone array arranged on the headset body for collecting sounds generated by a sound source. The microphone array includes a plurality of microphones. The device includes: an acquisition circuitry, a distance determination circuitry, and a calibration circuitry.

The acquisition circuitry is configured to obtain a preset reference distance of each microphone. The preset reference distance is a distance between each microphone and the sound source when the headset body is in a preset body direction. The acquisition circuitry is further configured to obtain a preset acoustic parameter reference value of each microphone. The preset acoustic parameter reference value is an acoustic parameter reference of each microphone corresponding to the headset body in the preset body direction and used for calibrating the microphone array.

The distance determination circuitry is configured to detect a current body direction of the headset body, and determine a distance between each microphone and the sound source to obtain a target distance of each microphone corresponding to a determination that a detected current body direction of the headset body is deflected relative to the preset body direction.

The calibration circuitry is configured to compare the target distance of each microphone with the preset reference distance of a corresponding microphone, and update the preset acoustic parameter reference value of each microphone according to a comparison result to obtain a target acoustic parameter value of each microphone, and calibrate the microphone array according to the target acoustic parameter value of each microphone of the microphone array.

In a third aspect, the present application further provides a headset, including a headset body, a microphone array arranged on the headset body, a memory and a processor. The microphone array includes a plurality of microphones. The memory has a computer program stored thereon. The microphone array is configured for collecting sounds generated by a sound source, and the processor, when executing the computer program, executes steps of: obtaining a preset reference distance of each microphone, the preset reference distance being a distance between each microphone and the sound source when the headset body is in a preset body direction; detecting a current body direction of the headset body, and determining a distance between each microphone and the sound source to obtain a target distance of each microphone corresponding to a determination that a detected current body direction of the headset body is deflected relative to the preset body direction; obtaining a preset acoustic parameter reference value of each microphone, the preset acoustic parameter reference value being an acoustic parameter reference of each microphone corresponding to the headset body in the preset body direction and used for calibrating the microphone array; comparing the target distance of each microphone with the preset reference distance of a corresponding microphone, and updating the preset acoustic parameter reference value of each microphone according to a comparison result, to obtain a target acoustic parameter value of each microphone; and calibrating the microphone array according to the target acoustic parameter value of each microphone of the microphone array.

In a fourth aspect, the present application further provides a non-transitory computer-readable storage medium, having a computer program stored thereon. The computer program, when executed by a processor, implements steps of: obtaining a preset reference distance of each microphone, the preset reference distance being a distance between each microphone and the sound source when the headset body is in a preset body direction; detecting a current body direction of the headset body, and determining a distance between each microphone and the sound source to obtain a target distance of each microphone corresponding to a determination that a detected current body direction of the headset body is deflected relative to the preset body direction; obtaining a preset acoustic parameter reference value of each microphone, the preset acoustic parameter reference value being an acoustic parameter reference of each microphone corresponding to the headset body in the preset body direction and used for calibrating the microphone array; comparing the target distance of each microphone with the preset reference distance of a corresponding microphone, and updating the preset acoustic parameter reference value of each microphone according to a comparison result, to obtain a target acoustic parameter value of each microphone; and calibrating the microphone array according to the target acoustic parameter value of each microphone of the microphone array.

In a fourth aspect, the present application further provides a computer program product, having a computer program stored thereon. The computer program, when executed by a processor, causes the processor to perform steps of: obtaining a preset reference distance of each microphone, the preset reference distance being a distance between each microphone and the sound source when the headset body is in a preset body direction; detecting a current body direction of the headset body, and determining a distance between each microphone and the sound source to obtain a target distance of each microphone corresponding to a determination that a detected current body direction of the headset body is deflected relative to the preset body direction; obtaining a preset acoustic parameter reference value of each microphone, the preset acoustic parameter reference value being an acoustic parameter reference of each microphone corresponding to the headset body in the preset body direction and used for calibrating the microphone array; comparing the target distance of each microphone with the preset reference distance of a corresponding microphone, and updating the preset acoustic parameter reference value of each microphone according to a comparison result, to obtain a target acoustic parameter value of each microphone; and calibrating the microphone array according to the target acoustic parameter value of each microphone of the microphone array.

In the method and device for calibrating the microphone array of the headset and the headset, the current body direction of the headset body is detected, and corresponding to the determination that the detected current body direction of the headset body is deflected relative to the preset body direction, the target distance between each microphone and the sound source can be automatically detected, and the target distance of each microphone is compared with the reference distance of the corresponding microphone, then the preset acoustic parameter reference value of each microphone is updated according to the comparison result to obtain the target acoustic parameter value of each microphone, and then the microphone array is calibrated based on the target acoustic parameter value of each microphone of the microphone array. In this way, when the current body direction of the headset body is deflected relative to the preset body direction, the preset acoustic parameter reference value of each microphone of the microphone array can be updated to adapt to the change in the distance between each microphone and the sound source, so that the microphone array can be accurately calibrated, thereby improving the quality of the sound collected by the microphone array.

### BRIEF DESCRIPTION OF THE DRAWINGS

In order to more clearly illustrate the technical solutions in the embodiments of the present application or related technologies, the drawings required for use in the embodiments of the present application or related technical descriptions will be briefly described below. Obviously, the drawings described below are only some embodiments of the present application. For the ordinary skilled in the art, other related drawings may be obtained based on these drawings without creative efforts.

FIG. 1 is a schematic flow chart of a method for calibrating a microphone array of a headset according to an embodiment;

FIG. 2 is a schematic diagram showing a headset body worn in a preset body direction according to an embodiment;

FIG. 3 is a schematic diagram showing a headset body worn in a current direction according to an embodiment;

FIG. 4 is a schematic diagram showing various position points according to an embodiment;

FIG. 5 is a schematic flow chart of simplified steps of calibrating a microphone array process according to an embodiment;

FIG. 6 is a block diagram showing a structure of a device for calibrating a microphone array of a headset according to an embodiment;

FIG. 7 is a view showing an internal structure of a headset according to an embodiment.

### DETAILED DESCRIPTION OF THE EMBODIMENTS

In order to make the objectives, technical solution and advantages of the present application clearer and be better understood, the present application is further described in detail below with reference to the accompanying drawings and embodiments. It should be understood that the specific embodiments described herein are only used to explain the present application but not used to limit the present application.

In the related art, when a user actually wears a headset, a microphone array is calibrated based on acoustic parameter reference values of each microphone, so the sound collected by the microphone array has the problem of poor quality.

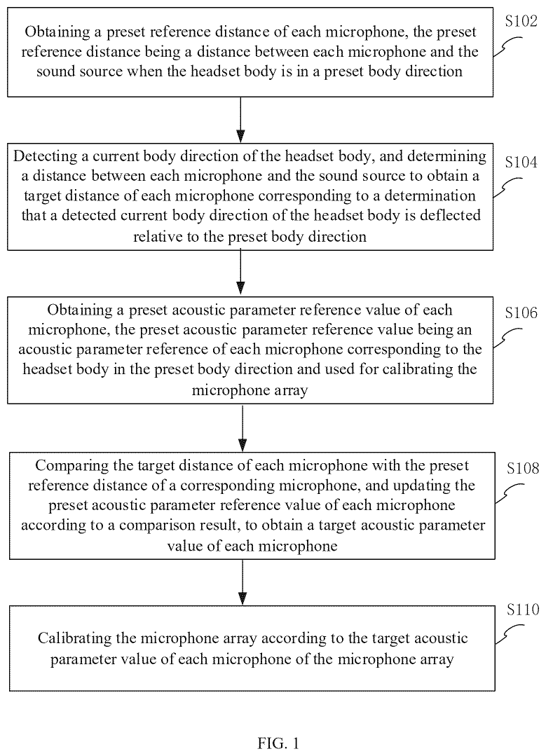

In an exemplary embodiment, as shown in FIG. 1, a method for calibrating a microphone array of a headset is provided. This embodiment is described by taking the method applied to a headset as an example. The headset includes a headset body, and a microphone array arranged on the headset body for collecting sounds generated by a sound source. The microphone array includes a plurality of microphones. In the embodiments of the present application, the sounds collected by the microphone array of the headset are voices generated by the mouth of a user, namely the sound source is located at a position of the mouth. In this embodiment, the method includes the following steps 102 to 110.

In step 102, a preset reference distance of each microphone is obtained. The preset in reference distance is a distance between each microphone and a sound source when the headset body is in a preset body direction.

The reference distance can be set according to the situation that the headset is worn on the human head. The headset body is in the preset body direction, which may be that the current body direction of the headset body is the same as the preset body direction. The reference distance may be set according to engineering experience.

The reference distance may also be obtained based on actual tests. For example, when the headset is worn on different human heads, the headset body of the headset may be adjusted to the preset body direction. Corresponding to each human head, the distance between each microphone and the sound source of the human head is measured. Based on the distances between each microphone and the sound sources of different human heads, the reference distance of each microphone is determined. For example, for each microphone, the average value of the distances between the corresponding microphone and the sound sources of different human heads may be calculated to obtain the reference distance of the corresponding microphone.

Exemplarily, a controller of the headset may obtain the preset reference distance of each microphone pre-stored in a memory of the headset.

In Step 104, a current body direction of the headset body is detected, and corresponding to a determination that the detected current body direction of the headset body is deflected relative to the preset body direction, a distance between each microphone and the sound source is determined to obtain a target distance of each microphone.

The headset includes the headset body, and the headset body may include a headset shell and a headset headband. The headset shell is configured to be worn on the ear position of the human head, and the headset headband is configured to fix the headset on the human head. The headset body includes a microphone array and a controller, and may also include a sound generating unit. The sound generating unit is configured to play sound. The headset can be connected to an electronic device with a communication function for making voice calls, such as a telephone, a personal computer, a laptop, a mobile phone, a tablet computer, or any other device. The method for calibrating the microphone array of the headset may be performed when the headset is worn on the human head, and may also be performed when the headset is not worn.

The microphone array includes a plurality of microphones, which may be three microphones or more than three microphones. Each microphone of the microphone array may be arranged at a different position of the headset body. For example, the headset body may include two headset shells, and the microphones of the microphone array may be installed on an outer side of a headset shell, and the microphones may be distributed at different positions on the outer side of the headset shell.

The body direction is an overall body direction of the headset body. The body direction may be an axial direction of the headset body, specifically, may be the direction in the axis of the headset body pointing from the bottom end of the headset body to the top end of the headset body. The bottom end of the headset body may be an end away from the top of the human head when the headset body is worn on the human head, and the top end of the headset body may be the end close to the top of the head.

The preset body direction is a body direction which is preset. The preset body direction may be a vertical axis direction in the earth coordinate system, and the vertical axis direction in the earth coordinate system may specifically be the positive vertical axis direction in the earth coordinate system. The preset body direction may also be a central axis direction of the human head wearing the headset body, and the central axis direction of the human head may specifically be the direction of the central axis of the human head from the chin to the top of the head.

Exemplarily, the current body direction of the headset body is detected, and corresponding to the determination that the detected current body direction of the headset body is deflected relative to the preset body direction, the controller of the headset can obtain a body deflection angle of the current body direction of the headset body relative to the preset body direction, a preset reference position relationship of each microphone is obtained, and the distance between each microphone and the sound source is determined to obtain the target distance of each microphone based on the body deflection angle and the reference position relationship of each microphone.

The reference position relationship characterizes the position relationship between each microphone, a body center of the headset body, and the sound source corresponding to the headset body in the preset body direction.

In an embodiment, the controller of the headset can detect the body deflection angle by which the body direction of the headset body deflects relative to the preset body direction, and when the body deflection angle meets a preset deflection condition, the controller of the headset can determine that the detected body direction of the headset body is detected relative to the preset body direction. An inertial measurement unit (IMU) may be arranged inside the headset body, and the controller of the headset can detect the body deflection angle through the IMU. The preset deflection condition may be that the body deflection angle is greater than the preset deflection angle, and the preset deflection angle may be, for example, 0, 1 degree, 3 degrees, etc.

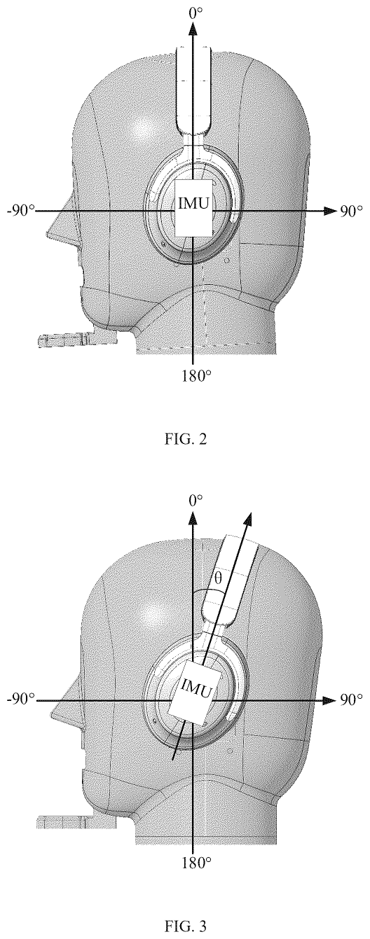

For example, referring to FIG. 2, a schematic diagram showing a headset body worn in a preset body direction according to an embodiment, the IMU is arranged inside the headset body, and the preset body direction may be set as a 0° direction. A direction opposite to the preset body direction is a 180° direction, and directions perpendicular to the preset body direction include one 90° direction and another −90° direction. Referring to FIG. 3, a schematic diagram showing a headset body worn in a current direction according to an embodiment, the IMU can detect an angle θ between the current body direction of the headset body and the preset body direction, namely the body deflection angle.

In Step 106, a preset acoustic parameter reference value of each microphone is obtained. The preset acoustic parameter reference value is an acoustic parameter reference of each microphone corresponding to the headset body in the preset body direction and is used for calibrating the microphone array.

The preset acoustic parameter reference value may be set according to engineering experience or be obtained by debugging when the headset body of the headset is in the preset body direction. The acoustic parameter can include at least one of a sensitivity and a phase, and can also include other parameters.

The sensitivity can characterize the ability of the microphone to convert sound signals into electrical signals. The higher the sensitivity, the stronger the ability of the microphone to capture the sound signals. The phase can characterize a phase difference between the sound signal received by a microphone and a sound signal received by any other microphone in the microphone array. Since different microphones in the microphone array are located at different positions relative to the sound source (such as the mouth), the time durations from the time point the sound source generates the sound to the time points the sound reaches different microphones may be different. As a result, there would be phase differences between the sound signals received by different microphones.

Exemplarily, the controller of the headset may obtain the preset acoustic parameter reference value of each microphone that is pre-stored in the memory of the headset.

In Step 108, the target distance of each microphone is compared with the reference distance of the corresponding microphone, and according to a comparison result, the preset acoustic parameter reference value of each microphone is updated to obtain the target acoustic parameter value of each microphone.

The comparison result of the target distance of each microphone and the reference distance of the corresponding microphone is a difference between the target distance of each microphone and the reference distance of the corresponding microphone, or may be a ratio of the target distance of each microphone to the reference distance of the corresponding microphone.

Exemplarily, the acoustic parameter reference value may include a phase reference value. In an embodiment of the present application, the controller of the headset can determine a phase change value of each microphone according to the difference between the target distance of each microphone and the reference distance of the corresponding microphone, and can update the phase reference value of each microphone according to the phase change value of each microphone to obtain the target phase value of each microphone.

In an embodiment, the acoustic parameter reference value may include a sensitivity reference value. In an embodiment of the present application, the controller of the headset can determine a sensitivity change value of each microphone according to the ratio of the target distance of each microphone to the reference distance of the corresponding microphone, and can update the sensitivity reference value of each microphone based on the sensitivity change value of each microphone to obtain the target sensitivity value of each microphone.

In an embodiment, the controller of the headset may use at least one of the target sensitivity value or the target phase value of each microphone as the target acoustic parameter value of each microphone.

In Step 110, the microphone array is calibrated according to the target acoustic parameter value of each microphone of the microphone array.

Exemplarily, the controller of the headset can calibrate a weight vector of each microphone of the microphone array according to the target acoustic parameter value of each microphone of the microphone array, so as to calibrate a main lobe direction of the microphone array.

The weight vector of a microphone may characterize a contribution of the sound signal received by the microphone to the sound signal outputted by the microphone array. It can be understood that according to the weight vector of each microphone in the microphone array, a weighted superposition of sound signals received by all microphones in the microphone array may be generated to form the sound signal outputted by the microphone array. The main lobe direction may represent a range of the main sound receiving directions of the microphone array, and may characterize the range of the directions in which the microphone array responds most strongly to the received sound signal. By calibrating the weight vector of each microphone, the main lobe direction of the microphone array can point in the direction of the effective sound source, for example, pointing in the direction of the mouth of the human head wearing headsets, so as to improve the effect of reducing the noise and improve the quality of the sound produced by the sound source collected by the microphone array.

In an embodiment, the target acoustic parameter value may include the target phase value and the target sensitivity value. In an embodiment of the present application, the controller of the headset may use the target phase value and the target sensitivity value of each microphone as input parameters of a digital signal processing (DSP) algorithm, and calibrates the weight vector of each microphone through the DSP algorithm to calibrate the main lobe direction of the microphone array.

In the method for calibrating the microphone array of the headset, the current body direction of the headset body is detected, and corresponding to the determination that the detected current body direction of the headset body is deflected relative to the preset body direction, the target distance between each microphone and the sound source can be automatically detected, and the target distance of each microphone is compared with the reference distance of the corresponding microphone, then the preset acoustic parameter reference value of each microphone is updated according to the comparison result to obtain the target acoustic parameter value of each microphone, and then the microphone array is calibrated based on the target acoustic parameter value of each microphone of the microphone array. In this way, when the current body direction of the headset body is deflected relative to the preset body direction, the preset acoustic parameter reference value of each microphone of the microphone array can be updated to adapt to the change in the distance between each microphone and the sound source, so that the microphone array can be accurately calibrated, thereby improving the quality of the sound collected by the microphone array.

In an exemplary embodiment, the step 104 of determining the distance between each microphone and the sound source to obtain the target distance of each microphone includes: obtaining the preset reference position relationship of each microphone, where the preset reference position relationship characterizes the position relationship between each microphone, the body center of the headset body, and the sound source corresponding to the headset body in the preset body direction; obtaining a preset distance of each microphone, where the preset distance is a distance between each microphone and the body center; determining a distance between each microphone and the sound source according to the body deflection angle of the body direction relative to the preset body direction, and the reference position relationship, the reference distance and the preset distance of each microphone, to obtain the target distance of each microphone.

The reference position relationship may include a first relative direction and a second direction of each microphone. The first relative direction may be a relative direction of the body center of the headset body relative to the position of each microphone corresponding to the headset body in the preset body direction, and the second relative direction may be a relative direction of the position of the sound source relative to the position of each microphone corresponding to the headset body in the preset body direction.

The body center represents a center position of the headset body. The body center may be pre-configured, for example, may be a center position of the headset shell of the headset body. The microphone array may be installed at the outer surface of the headset shell away from the side worn on the ear, and the body center may be the center position of the outer surface of the headset shell.

The preset distance is a distance preset between each microphone and the body center. The preset distance may be, for example, 4 cm, 5 cm or others. It may be understood that the preset distances of the microphones of the microphone array may be the same or different. When the headset body is in the preset body direction, or when the body direction of the headset body is deflected relative to the preset body direction, the preset distance of the same microphone in the microphone array may remain unchanged.

In this embodiment, when the headset body is in the preset body direction, the target distance of each microphone can be determined by presetting the position relationship between each microphone and the body center of the headset body and the sound source, and the known preset distance between each microphone and the body center, combining with the body deflection angle of the body direction relative to the preset body direction, thereby providing a base for accurately calibrating the microphone array.

In an embodiment, the reference position relationship may include a reference angle of each microphone, and the reference angle of each microphone may be an angle formed between the first relative direction and the second relative direction. The controller of the headset may take the body deflection angle of the headset body relative to the preset body direction as a target deflection angle of each microphone. The preset reference position relationship of each microphone is obtained, and the preset distance of each microphone is obtained. The distance between each microphone and the sound source is determined based on the geometric model of each microphone, the preset distance of each microphone, the reference distance of each microphone, the reference angle of each microphone and the target deflection angle of each microphone, to obtain the target distance of each microphone.

The target deflection angle may be an angle formed by a third relative direction and a fourth relative direction of each microphone. The third relative direction may be a relative direction from a current position of each microphone to the position of the body center of the headset body, and the fourth relative direction may be a relative direction from the position of each microphone corresponding to the headset body in the preset body direction relative to the position of the body center.

A geometric model can be constructed based on the position of the body center, the position of the sound source, and the current position of each microphone, and the position of each microphone when the headset body is in a preset body direction. The geometric model may be, for example, a triangular model, and the triangular model of each microphone can be constructed based on three of the four positions which include the position of the body center, the position of the sound source, and the current position of each microphone, and the position of each microphone when the headset body is in a preset body direction.

In an exemplary embodiment, the body center is a center of the three-dimensional space. In the three-dimensional space, each microphone, when the headset body is in a preset body direction, is represented by a reference position point according to the relative position of each microphone relative to the body center. In three-dimensional space, the sound source is represented by a sound source position point according to its position relative to the body center. The reference position relationship includes the reference angle of each microphone, and the reference angle is formed by a first vector and a second vector. The first vectors is a vector pointing from the reference position point of each microphone to the center, and the second vector is a vector pointing from the reference position point of each microphone to the sound source position point.

The three-dimensional space may be a real three-dimensional space or a virtual three-dimensional space. For example, the body center, each microphone, and the position of the sound source may be simplified as points in the real three-dimensional space, and the relationship between the body center, each microphone and the sound source may be simplified as vectors formed by points and simplified as angles between vectors, etc. In another example, the body center, each microphone and the position of the sound source may be mapped to points in the virtual three-dimensional space, and the relationship between the body center, each microphone, and the sound source may be mapped to vectors formed by points and angles between vectors, etc., in the virtual three-dimensional space.

In the situation that the headset body is in the preset body orientation, the relative position of each microphone relative to the body center may be the same as the relative position of the reference position point of each microphone relative to the center. The relative position of the sound source relative to the body center may be the same as the relative position of the sound source position point relative to the center.

It may be understood that the reference angle of each microphone may be formed by the first vector and the second vector of each microphone. In an embodiment, the first vector and the second vector may characterize the aforementioned first and second relative directions respectively. It may be understood that the first relative direction may also be represented by a half line from the reference position point of each microphone to the center, and the second relative direction may also be represented by a half line from the reference position point of each microphone to the sound source position point.

In an embodiment, the body center, each microphone and the sound source are represented by position points in three-dimensional space respectively, and the reference position relationship may be represented by the angle formed between vectors formed by the position points, thereby simplifying the position relationship between the body center, the microphone and the sound source, and thereby quickly determining the distance between each microphone and the sound source.

In an exemplary embodiment, in the three-dimensional space, a current relative position of each microphone relative to the body center is represented by a target position point. The step of determining the distance between each microphone and the sound source according to the body deflection angle of the body direction relative to the preset body direction, and the reference position relationship, the reference distance and the preset distance of each microphone includes following steps.

The body deflection angle is determined as the target deflection angle of each microphone. The target deflection angle is the angle formed by the third and fourth vectors of each microphone. The third vector is a vector pointing from the center to the reference position point of each microphone, and the fourth vector is a vector pointing from the center to the target position point of each microphone. The distance between each microphone and the sound source is determined based on the triangle model corresponding to each microphone, the preset distance of each microphone, the reference distance of each microphone, the reference angle of each microphone and the target deflection angle of each microphone. The triangle model is constructed by triangle vertices of three among the four points, which include the center, the sound source position point, the target position point of each microphone and the reference position point of each microphone.

The current relative position of each microphone relative to the body center may be the same as the relative position of the target position point of each microphone relative to the center. It can be understood that the target deflection angle of each microphone may be the same and may be the same as the deflection angle of the body. The triangle model is a model corresponding to a triangle formed by connecting three triangle vertices in sequence. For the triangle model, various triangle theorems can be used to solve internal angles of the corresponding triangle, side lengths of the corresponding triangle, etc. The triangle theorems may include the triangle interior angle sum theorem, the isosceles triangle theorem, and the cosine theorem, etc.

In an embodiment, a current relative position to the body center of each microphone is represented by a target position point, and the body deflection angle is the target deflection angle of each microphone. Thereby, three points among the center, the sound source position point, and the reference position point and the target position point of each microphone may be used to construct the triangular model, and the distance between the microphone and the sound source is efficiently determined based on the triangular model and the known angles and distances.

In an exemplary embodiment, the step of determining the distance between each microphone and the sound source based on the triangle model corresponding to each microphone, the preset distance of each microphone, the reference distance of each microphone, the reference angle of each microphone and the target deflection angle of each microphone may include following steps.

An isosceles triangle model corresponding to each microphone is determined. The isosceles triangle model is constructed by taking the center, the target position point and the reference position point of each microphone as triangle vertices. A target triangle model corresponding to each microphone is determined. The target triangle model is constructed by taking the sound source position point, the target position point of each microphone, and the reference position point of each microphone as triangle vertices. The distance between the target position point of each microphone and the sound source position point is determined to obtain the distance between each microphone and the sound source, according to the isosceles triangle model corresponding to each microphone and the target triangle model corresponding to each microphone, and based on the preset distance of each microphone, the reference distance of each microphone, the reference angle of each microphone, and the target deflection angle of each microphone.

Among them, since the distance from the target position point of each microphone to the center and the distance from the reference position point of the corresponding microphone to the center are the same, and both may be the preset distance of the corresponding microphone. Therefore, the triangle formed by connecting the center, the target position point of each microphone and the reference position point of the corresponding microphone in sequence is an isosceles triangle.

In an embodiment, the isosceles triangle model corresponding to each microphone and the target triangle model corresponding to each microphone are determined. The distance between the target position point of each microphone and the sound source position point can be efficiently determined according to these two triangle models, the known angles and the known distances, thereby obtaining the distance between the microphone and the sound source.

In one of the embodiments, the controller of the headset may determine the distance between the target position point of each microphone and the reference position point of each microphone according to the cosine theorem in the isosceles triangle model corresponding to each microphone and based on the target deflection angle of the corresponding microphone and the preset distance of the corresponding microphone, so as to obtain the deflection distance of each microphone. A base angle corresponding to each microphone in the corresponding isosceles triangle is determined according to the target deflection angle of each microphone. A target inner angle in the target triangle model corresponding to each microphone is determined according to the reference angle of each microphone and the base angle corresponding to each microphone. The distance between the target position point of each microphone and the sound source position point is determined according to the cosine theorem of the target triangle model corresponding to each microphone, and based on the deflection distance of each microphone, the target inner angle, and the reference distance of the corresponding microphone, so as to obtain the distance between each microphone and the sound source.

The base angle is an angle in the isosceles triangle model taking the reference position point of each microphone as a vertice. The target inner angle is an angle in the target triangle model taking the reference position point of each microphone as a vertice. The value of the base angle can be determined based on the triangle interior angle sum theorem and the property of an isosceles triangle that angles corresponding to equal sides are equal. An absolute value of a difference between the reference angle and the base angle may be determined as the value of the target inner angle.

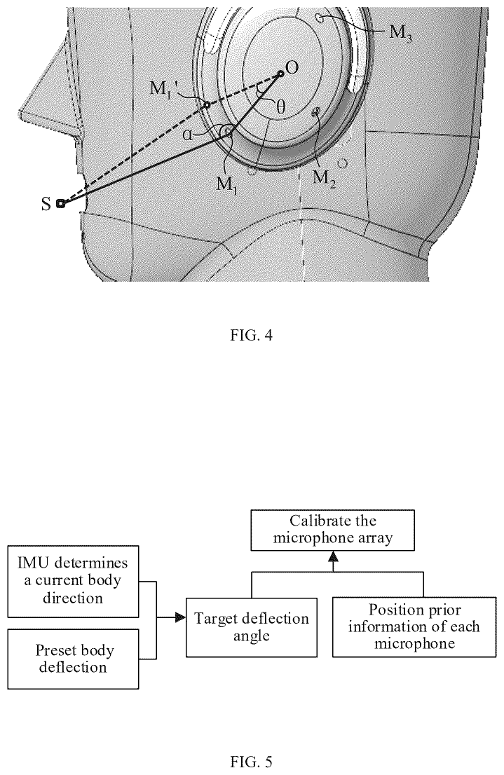

For example, the microphone array may include three microphones, which may be a microphone 1, a microphone 2, and a microphone 3 respectively. Referring to the FIG. 4, a schematic diagram showing various position points, the body center can be represented by the center O, and the sound source can be represented by the sound source position point S. The microphone 1, the microphone 2 and the microphone 3, when the headset body is in the preset body direction, may be represented by the reference position point M₁, the reference position point M₂, and the reference position point M₃, respectively.

Taking the microphone 1 as an example, the current position of the microphone 1 can be represented by the target position point M₁′. The preset distance of the microphone 1 may be a distance between the center O and the reference position point M₁, or the distance between the center O and the target position point M₁′, and both distances are equal. The reference distance of the microphone 1 may be the distance between the reference position point M and sound the source position point S. The isosceles triangle model corresponding to the microphone 1 may be constructed by taking the center O, the reference position point M₁, and the target position point M′ as triangle vertices, and the target triangle model corresponding to the microphone 1 may be constructed by taking the source position point S, the reference position point M₁, and the target position point M′ as triangle vertices. The reference angle of the microphone 1 may be the angle formed by the vector from the reference position point M₁ to the center O and the vector from the reference position point M₁, to the source position point S. As shown in FIG. 4, the angle <SM₁O may be the reference angle, and the reference angle may be represented by a. The target deflection angle of the microphone 1 may be the angle formed by the vector from the center O to the reference position point M and the vector pointing from the center O to the target position point M′. As shown in FIG. 4, the angle <M₁OM₁′ may be the target deflection angle, and the target deflection angle may be represented by θ.

In the isosceles triangle model corresponding to the microphone 1, the length of the side OM₁, formed by connecting the center O and the reference position M₁, or the length of the side OM₁, ‘formed by connecting the center O and the target position point M’, may be the preset distance. The distance between the reference position M₁, and the target position point M′ may be the deflection distance of the microphone 1, that is, the length of the side M₁M₁′ formed by connecting the reference position M₁, and the target position point M₁′ may be the deflection distance. It can be seen that in the isosceles triangle ΔM₁OM₁′, the length of the side OM₁′, the value of the angle <M₁OM₁′, and the length of the side OM₁′ are known. The length of the side M₁M₁′can be calculated based on the cosine theorem, so that the deflection distance of the microphone 1 can be obtained.

In the isosceles triangle model corresponding to the microphone 1, the angle having the reference position M₁, as the vertex may be represented by the angle >M₁′M₁O, and the angle <M′M₁O may be the base angle of the corresponding isosceles triangle model corresponding to the microphone 1, and the value of the angle <M₁′M₁O can be equal to (180°−θ)/2.

In the target triangle model corresponding to the microphone 1, the angle taking the reference position M₁, as the vertex may be represented by an angle <M₁′M₁S, and the angle <M₁′M₁S may be the target inner angle of the microphone 1, the value of the angle <M₁′M₁S may be an absolute value of the difference between the angle <SM₁,O and the angle <M₁′M₁O, which can be expressed as <M₁′M₁S=|α−(180−θ)/2. The length of the side M₁S formed by connecting the reference position M₁, and the source position point S may be the reference distance. It can be seen that in the target triangle ΔM₁SM₁′, the length of the side M S, the value of the angle <M₁′M₁S, and the length of the side M₁M₁′ are known. The length of the side M₁′S may be calculated based on the cosine theorem, to obtain the distance between the target position point of the microphone 1 and the sound source position point, namely, the target distance of the microphone 1. The target distances of other microphones in the microphone array may be determined in a similar manner, which will not be repeatedly described hereinafter.

The preset distance of any microphone in the microphone array may be represented by Mu, the reference distance of any microphone may be represented by S_{Li}, the reference angle of any microphone may be represented by αᵢ, the target distance of any microphone may be represented by S_{Li}′, and the body deflection angle or the target deflection angle of any microphone may be represented by θ, a sign “*” represents a multiply operation, where i may represent a serial number of the microphone, and may be 1, 2, or 3. Then, based on the above isosceles triangle model and the target triangle model, a calculation formula for the target distance of any microphone of the microphone array may be obtained as the following formula (1):

$${S}_{Li}^{′} = \sqrt{{S}_{Li}^{2} + 4 * {M}_{Li}^{2} * {sin}^{2} \frac{θ}{2} - 4 * {S}_{Li} * {M}_{Li} * sin \frac{θ}{2} * sin ( {α}_{i} + \frac{θ}{2} )} \qquad ( 1 )$$

In this way, for each microphone in the microphone array, the body deflection angle, the reference distance of the microphone, the preset distance of the microphone and the reference angle of the microphone may be substituted into the above formula (1) to calculate the target distance of the microphone.

In an exemplary embodiment, the step of determining the distance between each microphone and the sound source based on the triangle model corresponding to each microphone, the preset distance of the corresponding microphone, the reference distance of the corresponding microphone, the reference angle of the corresponding microphone and the target deflection angle of the corresponding microphone may be performed in the following mode including: determining a first triangular model corresponding to each microphone, where the first triangular model takes the center O, the sound source position point S, and the reference position point Mᵢ of each microphone as triangle vertices; determining a second triangular model corresponding to the corresponding microphone, where the target triangular model takes the center O, the sound source position point S, and the target position point Mᵢ′ of the corresponding microphone as triangle vertices; according to the first triangle model and the second triangle model corresponding to the corresponding microphone, and based on the preset distance of the corresponding microphone, the reference distance of the corresponding microphone, the reference angle of the corresponding microphone, and the target deflection angle of the corresponding microphone, the distance between the target position point of the corresponding microphone and the sound source position point is determined, to obtain the distance between each microphone and the sound source. Based on FIG. 4, taking the microphone 1 as an example, by taking the center O, the sound source position point S and the reference position point of the microphone 1 as vertices of a triangle, the first triangular model is determined, and the first triangular model corresponds to the triangle ΔOM₁S. By taking the center O, the sound source position point S, and the target position point of the microphone 1 as vertices a triangle, a second triangular model is determined, and the second triangular model corresponds to the triangle ΔOM₁′S. In the triangle ΔOM₁S, the length of the side OM₁ the value of the angle <SM₁O and the length of the side M S are all known, and the length of the side OS formed by the line connecting the center O and the source position point S may be calculated based on the cosine theorem. Thus the lengths of three sides of the triangle ΔOM₁S are known, and in the triangle ΔOM₁S, the value of the angle (which may be represented by <M₁OS) taking the center O as the vertex may be calculated based on the cosine theorem. According to the angles <M₁OM₁′ and <M₁OS, in the triangle ΔOM₁′S, the value of the angle (which may be represented by <M₁′OS) taking the center O as the vertex can be calculated. Thus, in the triangle ΔOM₁′S, the length of the side OM₁′, the value of the angle <M₁′OS, and the length of the side OS are all known. Based on the cosine theorem, the length of the side M₁′S may be calculated to obtain the distance between the target position point of the microphone 1 and the sound source position point, thus obtaining the target distance of the microphone 1. The target distances of other microphones in the microphone array may be determined in a similar manner, which will not be repeatedly described hereinafter.

In an exemplary embodiment, the acoustic parameter reference value includes the phase reference value and the sensitivity reference value, and the target acoustic parameter value includes the target phase value and the target sensitivity value. The step 108 of comparing the target distance of each microphone with the reference distance of the corresponding microphone, and according to the comparison result, updating the preset acoustic parameter reference value of each microphone to obtain the target acoustic parameter value of each microphone includes: determining a phase change value of each microphone according to a preset sound speed, an adapted sound frequency of the headset, and a difference between the target distance of each microphone and the reference distance of the corresponding microphone; performing a logarithmic operation to determine a sensitivity change value of each microphone according to a ratio of the target distance of each microphone to the reference distance of the corresponding microphone; updating the phase reference value of each microphone according to the phase change value of each microphone, to obtain the target phase value of each microphone; updating the sensitivity reference value of each microphone according to the sensitivity change value of each microphone, to obtain the target sensitivity value of each microphone.

The preset sound speed may be a transmission speed of sound in the air. The preset sound speed may be 340 m/s (meters per second). The sound frequency is a frequency of sound vibration. The sound frequency adapted to the headset may be preset for the headset, for example, the sound frequency may be 130 Hz, or 250 Hz, etc. The sound frequency adapted to the headset may also be a sound frequency calculated according to the sound which is collected in the initial period since the mouth on the human head starts to produce sound when the headset is worn on the human head. The initial period may be within 1 second since the sound starts to be generated.

Exemplarily, for each microphone, the controller of the headset may determine the phase change value of the microphone according to the formula ΔPh=(ΔSLi/C0)×f, and determine the sensitivity change value of the microphone according to the formula ΔLevel=20×1 g (SLi′/SLi); obtain the target phase value of the microphone by adding the phase change value of the microphone and the phase reference value of the microphone; obtain the target sensitivity value of the microphone by adding the sensitivity change value of the microphone and the sensitivity reference value of the corresponding microphone.55

Where ΔPh represents the phase change value of the microphone, ΔSLi represents the difference between the target distance of the microphone and the reference distance of the microphone, CO represents the preset sound speed, f represents the adapted sound frequency of the headset, and the sign “/” represents a division operation. ALevel represents the sensitivity change value of the microphone, SLi′ represents the target distance of the microphone, SLi represents the reference distance of the microphone, and the sign “lg” represents a logarithmic operation with 10 as the base.

In this embodiment, the phase change value of each microphone is calculated according to the difference between the target distance of each microphone and the reference distance of the corresponding microphone. The sensitivity change value of each microphone is calculated according to the ratio of the target distance of each microphone to the reference distance of the corresponding microphone. The phase reference value and the sensitivity reference value may be updated, so that the phase and the sensitivity of each microphone can change with the change of the target distance, thus providing a basis for accurately calibrating the microphone array.

In a specific embodiment, a schematic flow chart of simplified steps of calibrating a microphone array process may be shown in FIG. 5, through the IMU, the controller of the headset may determine the body direction of the headset body, compare the body direction with the preset body direction, and determine the body deflection angle of the body direction relative to the preset body direction; corresponding to the determination that the body direction of the headset body is deflected relative to the preset body direction based on the body deflection angle, determine the body deflection angle as the target deflection angle of each microphone; and obtain the position prior information of each microphone, where the position prior information may include a preset distance, a reference angle, and a reference distance; determine the target distance of each microphone based on the target deflection angle and the position prior information of each microphone; update the preset acoustic parameter reference value of each microphone according to the difference between the target distance of each microphone and the reference distance of the corresponding microphone, to obtain the target acoustic parameter value of each microphone; calibrate the microphone array based on the target acoustic parameter value of each microphone of the microphone array.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in this disclosure, the execution of these steps is not limited according to a strict order restriction, and these steps may be executed in other orders. Moreover, at least part of the steps in the flowcharts involved in the above-mentioned embodiments may include multiple steps or multiple stages, and these steps or stages are not necessarily executed at the same time, but may be executed at different time, and these steps or stages are not necessarily executed in sequence, but may be executed in turn or alternately with other steps or with at least part of the steps or stages in other steps.

Based on the same inventive conception, the embodiment of the present application also provides a device for calibrating a microphone array of a headset used to implement the method for calibrating the microphone array of the headset above. The solutions provided by the device for solving the problem is similar to the solutions for implementing the above-mentioned method, so the specific limitations in the embodiments of one or more devices for calibrating the microphone array of the headset below can refer to the limitations for the method for calibrating the microphone array of the headset above, which will not be repeatedly described herein.

In an exemplary embodiment, as shown in FIG. 6, a device for calibrating a microphone array of a headset 600 is provided. The headset includes a headset body, and a microphone array arranged on the headset body for collecting sounds generated by a sound source. The microphone array includes a plurality of microphones. The device includes: an acquisition circuitry 610, a distance determination circuitry 620, and a calibration circuitry 630.

The acquisition circuitry 610 is configured to obtain a preset reference distance of each microphone. The preset reference distance is a distance between each microphone and a sound source when the headset body is in a preset body direction. The acquisition circuitry 610 is further configured to obtain a preset acoustic parameter reference value of each microphone. The preset acoustic parameter reference value is an acoustic parameter reference of each microphone corresponding to the headset body in the preset body direction and is used for calibrating the microphone array.

The distance determination circuitry 620 is configured to detect a current body direction of the headset body, and corresponding to a determination that the detected current body direction of the headset body is deflected relative to the preset body direction, and determine a distance between each microphone and the sound source to obtain a target distance of each microphone.

The calibration circuitry 630 is configured to compare the target distance of each microphone with the reference distance of the corresponding microphone, and according to a comparison result, update the preset acoustic parameter reference value of each microphone to obtain the target acoustic parameter value of each microphone, and calibrate the microphone array according to the target acoustic parameter value of each microphone of the microphone array.

In an exemplary embodiment, the distance determination circuitry 620 is further configured to obtain the preset reference position relationship of each microphone. The reference position relationship characterizes the position relationship between each microphone, the body center of the headset body, and the sound source corresponding to the headset body in the preset body direction. The distance determination circuitry is further configured to obtain a preset distance of each microphone. The preset distance is a distance between each microphone and the body center; The distance determination circuitry is further configured to determine a distance between each microphone and the sound source according to the body deflection angle of the body direction relative to the preset body direction, and the reference position relationship, the reference distance and the preset distance of each microphone, to obtain the target distance of each microphone.

In an exemplary embodiment, the body center is a center of the three-dimensional space. In the three-dimensional space, each microphone, when the headset body is in a preset body direction, is represented by a reference position point according to the relative position of each microphone relative to the body center. In three-dimensional space, the sound source is represented by a sound source position point according to its position relative to the body center. The reference position relationship includes the reference angle of each microphone, and the reference angle is formed by a first vector and a second vector. The first vectors is a vector pointing from the reference position point of each microphone to the center, and the second vector is a vector pointing from the reference position point of each microphone to the sound source position point.

In an exemplary embodiment, in the three-dimensional space, a current relative position of each microphone relative to the body center is represented by a target position point. The distance determination circuitry 620 is further configured to determine the body deflection angle as the target deflection angle of each microphone. The target deflection angle is the angle formed by the third and fourth vectors of each microphone. The third vector is a vector pointing from the center to the reference position point of each microphone, and the fourth vector is a vector pointing from the center to the target position point of each microphone. The distance determination circuitry 620 is further configured to determine the distance between each microphone and the sound source based on the triangle model corresponding to each microphone, the preset distance of each microphone, the reference distance of each microphone, the reference angle of each microphone and the target deflection angle of each microphone. The triangle model is constructed by triangle vertices of three of the four points, which include the center, the sound source position point, the target position point of each microphone and the reference position point of each microphone.

In an exemplary embodiment, the distance determination circuitry 620 is further configured to determine an isosceles triangle model corresponding to each microphone. The isosceles triangle model is constructed by taking the center, the target position point and the reference position point of each microphone as triangle vertices. The distance determination circuitry 620 is further configured to determine a target triangle model corresponding to each microphone. The target triangle model is constructed by taking the sound source position point, the target position point of each microphone, and the reference position point of each microphone as triangle vertices. The distance determination circuitry 620 is further configured to determine the distance between the target position point of each microphone and the sound source position point to obtain the distance between each microphone and the sound source, according to the isosceles triangle model corresponding to each microphone and the target triangle model corresponding to each microphone, and based on the preset distance of each microphone, the reference distance of each microphone, the reference angle of each microphone, and the target deflection angle of each microphone.

In an exemplary embodiment, the acoustic parameter reference value includes the phase reference value and the sensitivity reference value, and the target acoustic parameter value includes the target phase value and the target sensitivity value. The calibration circuitry 630 is further configured to determine a phase change value of each microphone according to a preset sound speed, an adapted sound frequency of the headset, and a difference between the target distance of each microphone and the reference distance of the corresponding microphone, perform a logarithmic operation to determine a sensitivity change value of each microphone based on a ratio of the target distance of each microphone to the reference distance of the corresponding microphone, update the phase reference value of each microphone according to the phase change value of each microphone, to obtain the target phase value of each microphone, and update the sensitivity reference value of each microphone according to the sensitivity change value of each microphone, to obtain the target sensitivity value of each microphone.

The device for calibrating the microphone array of the headset can be implemented in whole or in part by software, hardware, or a combination thereof. Each of the above-mentioned modules can be embedded in or independent of a processor in a computer device in the form of hardware, or can be stored in a memory in a computer device in the form of software, so that the processor can call and execute operations corresponding to each of the above modules.

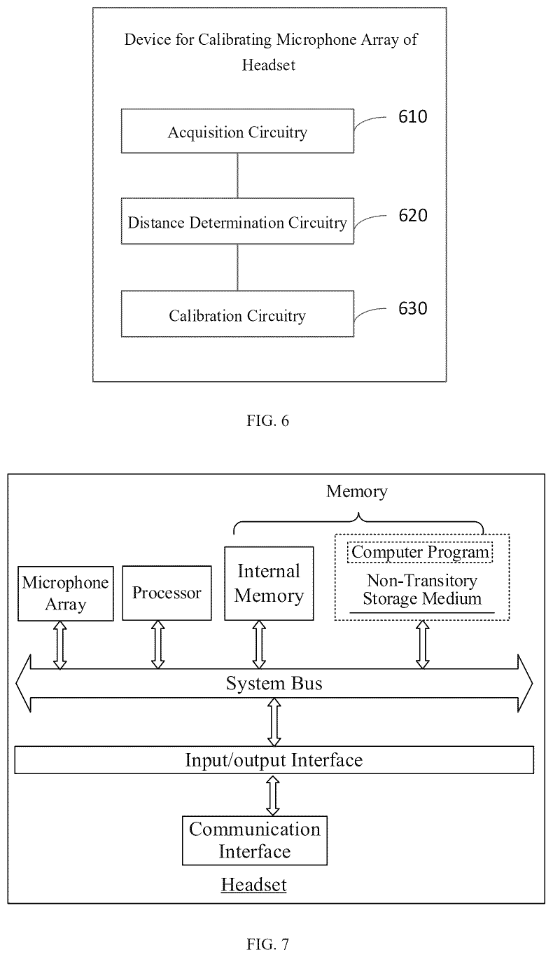

In an exemplary embodiment, a headset is provided, and the headset includes a headset body, and an internal structure diagram thereof may be as shown in FIG. 7. The headset includes a microphone array, a processor, a memory, an input/output interface (I/O interface) and a communication interface which are arranged in the headset body. The microphone array includes a plurality of microphones. The microphone array, the processor, the memory and the I/O interface are connected via a system bus, and the communication interface is connected to the system bus via the I/O interface. The microphone array of the headset is used to collect the sound generated by the sound source. The processor of the headset is used to provide computing and control capabilities. The memory of the headset includes a non-transitory storage medium and an internal memory. The non-transitory storage medium stores an operating system, a computer program and a database. The internal memory provides an environment for the operation of the operating system and the computer program in the non-transitory storage medium. The I/O interface of the headset is configured to exchange information between the processor and an external device. The communication interface of the headset is configured to communicate with an external terminal via a network connection. The processor, when executing the computer program, implements the method for calibrating the microphone array of the headset.

It should be understood by those skilled in the art that the configuration illustrated in FIG. 7, which is only a block diagram of part of the structure related to the solution of the present application, does not constitute a limitation on the headset to which the solution of the present application is applied. The specific headset may include more or fewer components than those shown in the figure, or may combine some components, or may have a different arrangement of components.

In an embodiment, a computer equipment is provided and includes a memory and a processor. A computer program is stored in the memory, and the processor, when executing the computer program, implements the steps in the above-mentioned method embodiments.

In an embodiment, a non-transitory computer-readable storage medium is provided and has a computer program stored thereon. The computer program, when executed by a processor, implement the steps in the above method embodiments.

In an embodiment, a computer program product is provided, and includes a computer program. The computer program, when executed by a processor, implements the steps in the above method embodiments.

It should be noted that the user information (including but not limited to user device information, user personal information, etc.) and data (including but not limited to data used for analysis, stored data, displayed data, etc.) involved in the present application are information and data authorized by the user or fully authorized by all parties, and the collection, usage and process of relevant data must comply with relevant regulations.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the procedures in the embodiments of the above methods. Any reference to memory, database or other medium used in the embodiments provided in the present application may include at least one of a non-volatile and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random-access memory (FRAM), a phase change memory (PCM), or a graphene memory, etc. The volatile memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present application may include at least one of a relational database and a non-relational database. The non-relational database may include, but is not limited to, a blockchain-based distributed database, etc. The processor involved in the embodiments provided by the present application may be, but is not limited to, a general-purpose processor, a central processor, a graphics processor, a digital signal processor, a programmable logic device, a data processing logic device based on quantum computation, an artificial intelligence (AI) processor, and the like.

It should be noted that in the present disclosure, relationship terms such as “first” and “second” are used only to distinguish one entity or operation from another, and do not necessarily require or imply any such actual relationship or order between these entities or operations. Further, the terms “include”, “include”, or any other variation thereof are intended to cover non-exclusive inclusion such that a process, a method, an object, or a device, including a series of elements, includes not only these elements, but also other elements that are not expressly listed or that are inherent to such process, method, object, or device. Without further limitation, the element defined by the statement “including a . . . ” do not exclude the existence of additional identical elements in the process, method, object or device including the element.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present application, and their description is specific and detailed, but should not be understood as a limitation on the patent scope of the present application. It should be noted that, for those skilled in the art, variations and improvements may be further made without departing from the conception of the present application, and these variations and improvements all fall within the protection scope of the present application. Therefore, the protection scope of the present application should be subject to the appended claims.

What is claimed is:

1. A method for calibrating a microphone array of a headset, wherein the headset comprises a headset body and a microphone array arranged on the headset body for collecting sounds generated by a sound source; the microphone array comprises a plurality of microphones; and the method comprises:
obtaining a preset reference distance of each microphone, the preset reference distance being a distance between each microphone and the sound source when the headset body is in a preset body direction;
detecting a current body direction of the headset body, and determining a distance between each microphone and the sound source to obtain a target distance of each microphone corresponding to a determination that a detected current body direction of the headset body is deflected relative to the preset body direction;
obtaining a preset acoustic parameter reference value of each microphone, the preset acoustic parameter reference value being an acoustic parameter reference of each microphone corresponding to the headset body in the preset body direction and used for calibrating the microphone array;
comparing the target distance of each microphone with the preset reference distance of a corresponding microphone, and updating the preset acoustic parameter reference value of each microphone according to a comparison result, to obtain a target acoustic parameter value of each microphone; and
calibrating the microphone array according to the target acoustic parameter value of each microphone of the microphone array.

2. The method according to claim 1, wherein determining the distance between each microphone and the sound source to obtain the target distance of each microphone comprises:
obtaining a preset reference position relationship of each microphone, the preset reference position relationship characterizing a position relationship between each microphone, a body center of the headset body, and the sound source corresponding to the headset body in the preset body direction;
obtaining a preset distance of each microphone, the preset distance being a distance between each microphone and the body center; and
determining a distance between each microphone and the sound source according to a body deflection angle of the body direction relative to the preset body direction, the reference position relationship, the preset reference distance and the preset distance of each microphone to obtain the target distance of each microphone.

3. The method according to claim 2, wherein the body center is a center of a three-dimensional space;
in the three-dimensional space, each microphone, when the headset body is in a preset body direction, is represented by a reference position point according to a relative position of each microphone relative to the body center;
in the three-dimensional space, the sound source is represented by a sound source position point according to a position of the sound source relative to the body center; and
the reference position relationship comprises a reference angle of each microphone; the reference angle is formed by a first vector and a second vector; the first vectors is a vector pointing from the reference position point of each microphone to the center, and the second vector is a vector pointing from the reference position point of each microphone to the sound source position point.

4. The method according to claim 3, wherein, in the three-dimensional space, a current relative position of each microphone relative to the body center is represented by a target position point; and
determining the distance between each microphone and the sound source according to the body deflection angle of the body direction relative to the preset body direction, the reference position relationship, the preset reference distance and the preset distance of each microphone to obtain the target distance of each microphone, comprises:
determining the body deflection angle as a target deflection angle of each microphone, the target deflection angle being an angle formed by a third vector and a fourth vector of each microphone; the third vector being a vector pointing from the center to the reference position point of each microphone, and the fourth vector being a vector pointing from the center to the target position point of each microphone; and
determining a distance between each microphone and the sound source based on a triangle model corresponding to each microphone, the preset distance of each microphone, the preset reference distance of each microphone, the reference angle of each microphone and the target deflection angle of each microphone; the triangle model being constructed by triangle vertices of three among four points comprising the center, the sound source position point, the target position point of each microphone and the reference position point of each microphone.

5. The method according to claim 4, wherein determining the distance between each microphone and the sound source based on the triangle model corresponding to each microphone, the preset distance of each microphone, the preset reference distance of each microphone, the reference angle of each microphone and the target deflection angle of each microphone, comprises:
determining an isosceles triangle model corresponding to each microphone, the isosceles triangle model being constructed by taking the center, the target position point and the reference position point of each microphone as triangle vertices;
determining a target triangle model corresponding to each microphone, the target triangle model being constructed by taking the sound source position point, the target position point of each microphone, and the reference position point of each microphone as triangle vertices; and
determining a distance between the target position point of each microphone and the sound source position point to obtain the distance between each microphone and the sound source, according to the isosceles triangle model corresponding to each microphone and the target triangle model corresponding to each microphone, and based on the preset distance of each microphone, the preset reference distance of each microphone, the reference angle of each microphone, and the target deflection angle of each microphone.

6. The method according to claim 5, wherein the distance between the target position point of each microphone and the sound source position point is
$${S}_{Li}^{′} = \sqrt{{S}_{Li}^{2} + 4 * {M}_{Li}^{2} * {sin}^{2} \frac{θ}{2} - 4 * {S}_{Li} * {M}_{Li} * sin \frac{θ}{2} * sin ( {α}_{i} + \frac{θ}{2} )}$$
wherein M_{Li} represents the preset distance of an i-th microphone, S_{Li} represents the preset reference distance of the i-th microphone, αᵢ represents the reference angle of the i-th microphone, and θ represents the deflection angle of the headset body, a sign “*” represents a multiply operation, and i is an integer greater than 1.

7. The method according to claim 4, wherein determining the distance between each microphone and the sound source based on the triangle model corresponding to each microphone, the preset distance of each microphone, the preset reference distance of each microphone, the reference angle of each microphone and the target deflection angle of each microphone, comprises:
determining a first triangular model corresponding to each microphone, the first triangular model taking the center (O), the sound source position point(S), and the reference position point (Mᵢ) of each microphone as triangle vertices;
determining a second triangular model corresponding to the corresponding microphone, the target triangular model taking the center (O), the sound source position point(S), and the target position point (Mᵢ) of the corresponding microphone as triangle vertices;
determining the distance between the target position point of each microphone and the sound source position point according to the first triangle model and the second triangle model corresponding to the corresponding microphone, and based on the preset distance of the corresponding microphone, the preset reference distance of the corresponding microphone, the reference angle of the corresponding microphone, and the target deflection angle of the corresponding microphone, to obtain the distance between the corresponding microphone and the sound source.

8. The method according to claim 1, wherein preset distances of the plurality of microphones are the same.

9. The method according to claim 1, wherein detecting the current body direction of the headset body comprises: detecting a body deflection angle of the current body direction of the headset body relative to the preset body direction;
the method further comprises determining that the detected current body direction of the headset body is deflected relative to the preset body direction when the body deflection angle is greater than a preset deflection angle.

10. The method according to claim 1, wherein the comparison result is a difference between the target distance and the preset reference distance of each microphone.

11. The method according to claim 1, wherein the comparison result is a ratio of the target distance to the preset reference distance of each microphone.

12. The method according to claim 1, wherein the acoustic parameter reference value comprises a phase reference value; and
comparing the target distance of each microphone with the preset reference distance of the corresponding microphone, and updating the preset acoustic parameter reference value of each microphone according to the comparison result to obtain the target acoustic parameter value of each microphone comprises:
determine a phase change value of each microphone according to a difference between the target distance of each microphone and the preset reference distance of the corresponding microphone, and
updating the phase reference value of the corresponding microphone according to the phase change value of the corresponding microphone to obtain the target phase value of the corresponding microphone.

13. The method according to claim 1, wherein the acoustic parameter reference value comprises a sensitivity reference value; and
comparing the target distance of each microphone with the preset reference distance of the corresponding microphone, and updating the preset acoustic parameter reference value of each microphone according to the comparison result to obtain the target acoustic parameter value of each microphone comprises:
determining a sensitivity change value of each microphone according to a ratio of the target distance of each microphone to the preset reference distance of the corresponding microphone; and
updating the sensitivity reference value of the corresponding microphone based on the sensitivity change value of the corresponding microphone to obtain the target sensitivity value of the corresponding microphone.

14. The method according to claim 1, wherein calibrating the microphone array comprises: calibrating a weight vector of each microphone.

15. The method according to claim 1, wherein the acoustic parameter reference value comprises a phase reference value and a sensitivity reference value, and the acoustic parameter target value comprises a target phase value and a target sensitivity value; and
determining a phase change value of each microphone according to a preset sound speed, an adapted sound frequency of the headset, and a difference between the target distance of each microphone and the preset reference distance of the corresponding microphone;
performing a logarithmic operation to determine a sensitivity change value of each microphone based on a ratio of the target distance of the corresponding microphone to the preset reference distance of the corresponding microphone;
updating the phase reference value of the corresponding microphone according to the in phase change value of the corresponding microphone to obtain the target phase value of the corresponding microphone;
updating the sensitivity reference value of the corresponding microphone according to the sensitivity change value of the corresponding microphone to obtain the target sensitivity value of the corresponding microphone.

16. The method according to claim 15, wherein the adapted sound frequency of the headset is preset according to the headset.

17. A device for calibrating a microphone array of a headset, wherein the headset comprises a headset body and a microphone array arranged on the headset body for collecting sounds generated by a sound source; the microphone array comprises a plurality of microphones; and the device comprises:
an acquisition circuitry configured to obtain a preset reference distance of each microphone, the preset reference distance being a distance between each microphone and the sound source when the headset body is in a preset body direction, and obtain a preset acoustic parameter reference value of each microphone, the preset acoustic parameter reference value being an acoustic parameter reference of each microphone corresponding to the headset body in the preset body direction and used for calibrating the microphone array;
a distance determination circuitry configured to detect a current body direction of the headset body, and determine a distance between each microphone and the sound source to obtain a target distance of each microphone corresponding to a determination that a detected current body direction of the headset body is deflected relative to the preset body direction; and
a calibration circuitry configured to compare the target distance of each microphone with the preset reference distance of a corresponding microphone, and update the preset acoustic parameter reference value of each microphone according to a comparison result to obtain a target acoustic parameter value of each microphone, and calibrate the microphone array according to the target acoustic parameter value of each microphone of the microphone array.

18. A headset, comprising a headset body, a microphone array arranged on the headset body, a memory and a processor; wherein the microphone array comprises a plurality of microphones; the memory has a computer program stored thereon; the microphone array is configured for collecting sounds generated by a sound source; and the processor, when executing the computer program, executes steps of the method according to claim 1.

19. A non-transitory computer-readable storage medium, having a computer program stored thereon, wherein the computer program, when executed by a processor, implements steps of the method according to claim 1.

20. A computer program product, comprising a computer program, wherein the computer program, when executed by a processor, causes the processor to perform steps of the method according to claim 1.
